(19) United States
(12) Patent Application Publication
(10) Pub. No.: US 2020/0182300 A1
(43) Pub. Date: Jun. 11, 2020

(54) CAGE FOR A BALL BEARING

(71) Applicant: Aktiebolaget SKF, Goteborg (SE)

(72) Inventors: Ezio Artero, Villar Perosa (IT); Piero Santangelo, Torino (IT)

(21) Appl. No.: 16/693,895

(22) Filed: Nov. 25, 2019

(30) Foreign Application Priority Data
Dec. 7, 2018 (IT) 102018000010887

(51) Int. Cl. F16C 33/42; F16C 19/06

(52) U.S. Cl. CPC F16C 33/42; F16C 19/06

(57) ABSTRACT

A cage for a ball bearing having a meandering wire which, extending around an axis of rotation (X) of the bearing of the ball type, defines a plurality of seats for receiving respective balls of the ball-type bearing. Further, the cage being also provided with a separating element between each pair of adjacent seats and, for each seat, with three points (P) of contact between balls and meandering wire for retaining the balls inside the associated seat. The separating element being formed by the same meandering wire and the points (P) of contact lying on the same meandering wire.

### CLAIM OF PRIORITY

This application claims the benefit of priority to Italian Application No. 102018000010887 of the same title filed on Dec. 7, 2018, under 35 U.S.C. § 119, the entire contents of which are incorporated herein by reference.

### FIELD

The present disclosure relates to the technological field of ball bearings.

### BACKGROUND

Ball bearing cages, also known as a ball bearing retainer or ball separator, are annular structures formed about an axis of rotation of a bearing so as to form a respective seat for each ball bearing.

### BRIEF DESCRIPTION OF THE DRAWINGS

The inventive concepts will now be described with reference to the attached drawings which illustrate non-limiting exemplary preferred embodiments thereof:

FIG. 1 is an exploded perspective view of an example embodiment of a ball bearing cage.

FIG. 2 is a perspective view, with parts removed for greater clarity, of the ball bearing cage as shown in FIG. 1.

FIG. 3 is a linear development view of the ball bearing cage as shown in FIG. 2.

FIG. 4 is a perspective view, with parts removed for greater clarity, of another example embodiment of the ball bearing cage illustrated in FIG. 1.

FIG. 5 is a linear development view of the ball bearing cage as shown in FIG. 4.

### DETAILED DESCRIPTION

The concepts disclosed herein are directed to a cage for a ball bearing that provides improvements over conventional ball bearing technology. In embodiments, a cage comprises a meandering wire defining, for each ball, a respective seat.

According to the concepts disclosed herein, a cage for a ball bearing comprising the characteristic features set forth in the attached claims is provided. Bearing cages, in particular cages comprising a meandering wire, that is a wire shaped about an axis of rotation of the bearing so as to form for each bearing a respective seat, are generally known in this field of art. For example, the International Patent Application WO 2016/096426, or the French Patent Application FR1559253, describe cages for bearings with revolving bodies, such as rollers or balls, in which the meandering wire is provided with separating and/or retaining elements associated with each seat so as to separate two adjacent seats from each other and/or retain the associated rolling body inside each seat.

The cages described in the aforementioned patent applications, while providing relatively low manufacturing costs by simply shaping a meandering wire, they do have a number of drawbacks precisely because of the presence of the separating and/or retaining elements, which increase both the costs and the production difficulties associated with them.

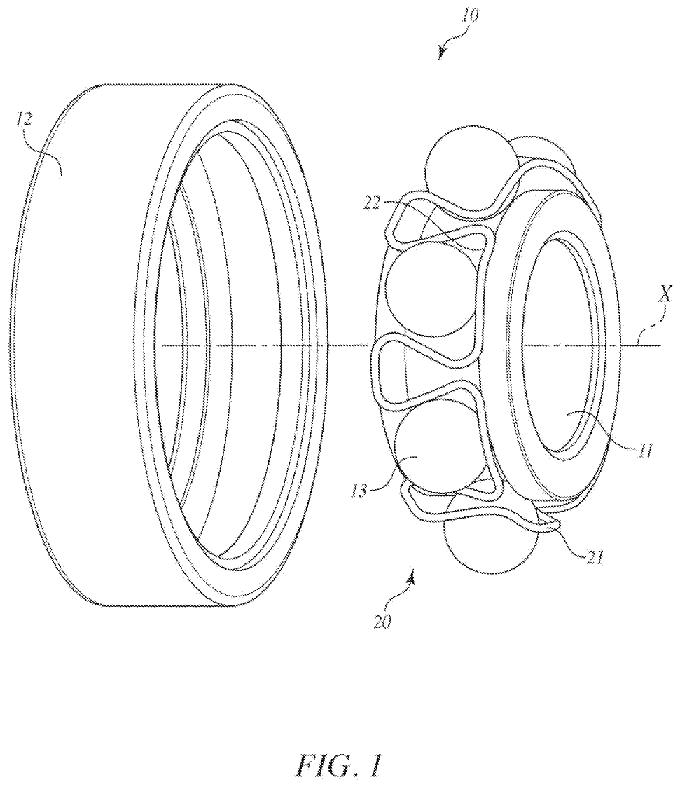

Now, the inventive concepts directed to the ball bearing cages will be discussed in greater detail. Referring to FIG. 1, a rolling bearing 10 having an axis of rotation X is illustrated. The rolling bearing 10 comprising an inner ring 11, an outer ring 12 and a plurality of rolling bodies 13, in this embodiment for example being balls, to which reference will be made hereinafter. The rolling bodies 13 are arranged between inner ring 11 and outer ring 12 so as to allow a relative rotation of the two rings 11 and 12 with respect to each other, and having the respective centres of the balls or rolling bodies 13 arranged on a circumference, called “pitch circle”, not particularly shown, with a diameter D1. The rolling bearing 10 also comprises a cage 20 for keeping the balls or rolling bodies 13 spaced from each other, thereby preventing or avoiding them from making contact with each other, and for creating the necessary spaces or separation for the introduction of any lubricant between them.

The cage 20 comprises a meandering wire 21, namely a wire 21, preferably, but not necessarily made of metallic material, which is shaped and extends around the axis of rotation X in a cylindrical development plane K (not shown) so as to define a plurality of seats 22 which are uniformly distributed around the axis X and each receive a corresponding ball 13 of the ball bearing 10. In particular, some exemplary embodiment, a cylindrical development plane K may be coaxial with an axis of rotation X and has a diameter D2 with dimensions smaller than dimensions of the diameter D1. Such geometrical form of the cage 20 compared to the size of the balls or rolling bodies 13 which it must retain, a smaller force may be exerted in order to insert the cage 20 into the rolling bearing 10. Accordingly, a smaller degree of flexing of the cage 20 may be required during the assembly of the rolling bearing 10 relative to known solutions.

In order to keep the balls or rolling bodies 13 spaced from each other, and preventing or avoiding contact between them, the cage 20 further comprises, for each pair of adjacent seats 22, separating elements 23. The separating elements 23 are arranged between each pair of adjacent seats 22 and includes, in the cylindrical development plane K, a substantially trapezoidal shape. The separating elements 23 are therefore arranged circumferentially alongside each other and define between them, and also delimit between them, an axial opening 24 for each associated seat 22 which, while on one axial side it is open in the region of the associated opening 24, on an axial side opposite to that of the associated opening 24, is axially delimited by an annular segment 25 of the meandering wire 21. The annular segments 25 of each seat are connected to the annular segments 25 of the other seats 22 by means of the separating elements 23 and are all arranged on a same circumference lying in the cylindrical development plane K.

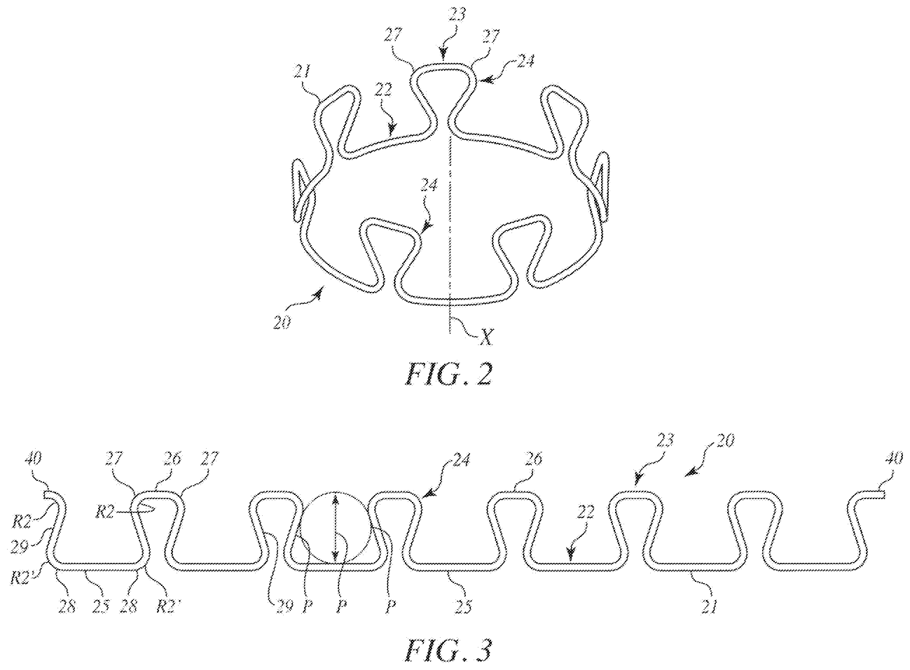

Next, FIGS. 2 and 3 will be discussed in detail. According to various exemplary embodiments of the cage 20 is also represented in FIGS. 2 and 3, wherein each separating element 23 is formed by a respective annular segment 26 having a linear development with dimensions smaller than the dimensions of a linear development of the respective annular segment 25.

The annular segments 26 of all the separating elements 23 are parallel to the annular segments 25 of the associated seats 22 and are also all arranged on a same circumference lying in the cylindrical development plane K. Moreover, each separating element 23 comprises two joining zones 27 with the same radius of curvature R2, arranged on opposite sides of the corresponding annular segment 26, while each seat 22 has, in the cylindrical development plane K, a substantially trapezoidal shape and comprises, in turn, two further joining zones 28 with the same radius of curvature R2′, arranged on opposite sides of the corresponding annular segment 25, and two inclined segments 29, each connected with a corresponding annular segment 25 by means of a corresponding joining zone 28 and with a corresponding annular segment 26 by means of a corresponding joining zone 27. The radii of curvature R2′ of the joining zones 28 include dimensions the same as the dimensions of the radii of curvature R2 of the joining zones 27.

In other words, the cage 20 formed by the meandering wire 21 may be defined by a succession of annular segments 26, joining zones 27, inclined segments 29, joining zones 28, annular segments 25 and joining zones 28, which provide the cage 20 with a structure which is sufficiently rigid to keep the balls or rolling bodies 13 in positions spaced apart from each other and, at the same time, with a structure which is equally elastic for allowing easy assembly of the cage 20 inside the rolling bearing 10.

In order to retain each ball or rolling body 13 inside the associated seat 22, each seat 22 has, in the embodiment of the cage 20 shown in FIGS. 2 and 3, three points P of contact between the balls or rolling bodies 13 and meandering wire 21. Wherein, the points P all lying on the same meandering wire 21, and in particular one point P lies on the annular segment 25 of the associated seat 22, and two further points P lie on the two separating elements 23 associated with the same seat 22. The positioning of the contact points P allows the balls or rolling bodies 13 to be retained inside the associated seats 22 and prevent or avoid the cage 20 from being accidentally expelled outside of the rolling bearing 10.

The points P which lie on the two separating elements 23 are arranged on the two separating elements 23 substantially in the region of the opening 24 of the associated seat 22, while the point P which lies on the annular segment 25 is arranged on the annular segment 25 in a position diametrically opposite to the associated opening 24 in relation to the associated ball or rolling body 13. Essentially, the three contact points P are arranged at the vertices of an equilateral triangle containing inside it an associated ball or rolling body 13 and, while the two points P which lie on the two separating elements 23 prevent the ball 13 from coming out of the seat 22 through the opening 24, the point P which lies on the annular segment 25 defines an axial contact point for the ball or rolling body 13 inside the associated seat 22. Finally, a play, or gap, is present between each respective ball or rolling body 13 and the three associated contact points P, so as to limit or avoid as far as possible the friction between the balls or the rolling bodies 13 and the meandering wire 21.

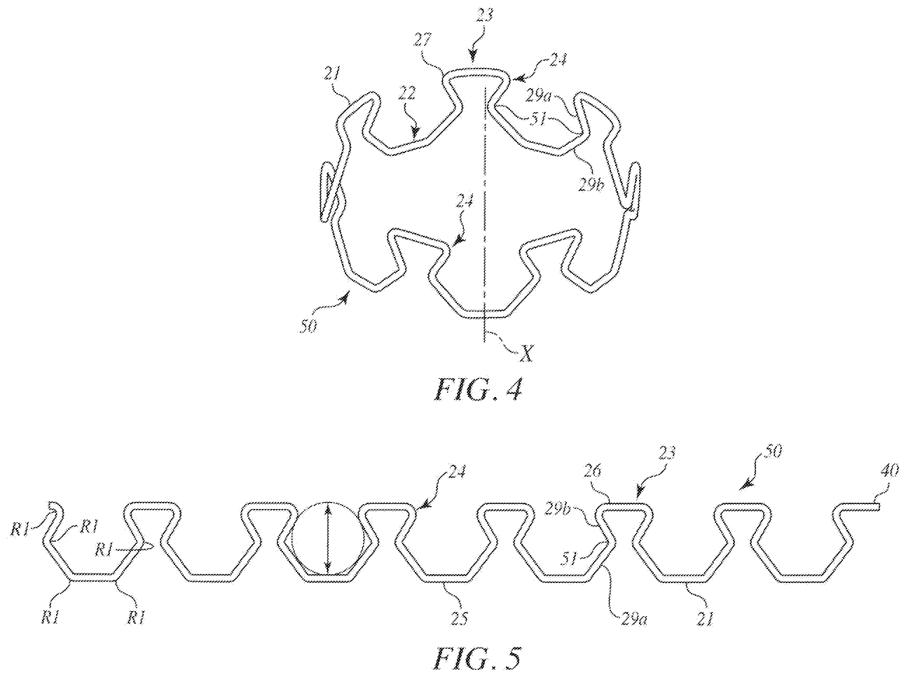

The example embodiment of the cage 20 described above and shown in FIGS. 4 and 5 relates again to a cage 50 for a bearing 10, where the cage 50 again comprises a meandering wire 21; however, it differs from the cage 20 discussed above in terms of the shape which each seat 22 has in the cylindrical development plane K. In fact, in the cage 50 shown in FIGS. 4 and 5, each seat 22 has, in the cylindrical development plane K, a substantially hexagonal shape and, therefore, the number of contact points P increases from the previous three points to the five points in this non-limiting example embodiment. Wherein, three of these points being positioned as already described above, while the other two contact points P being positioned substantially on the sides of each respective ball or rolling body 13 owing to the particular widened V-shaped form which the segments 29 of the cage 50 have.

In the cage 50, in fact, each segment 29 is composed of two sections 29a and 29b, which are connected together by a joining zone 51. The joining zone 51 includes a respective radius of curvature R1 with dimensions the same as the dimensions of the radii of curvature R1 of the joining zones 27 and 28 of the cage 50. Since in the cage 50 the number of linear sections which form each seat 22 is greater than the number of linear sections which form each seat of the cage 20, the amplitude of the radii of curvature R1 will be greater than the amplitude of the radii R2 described above.

The geometrical forms of the hexagonal seats 22 of the cage 50 improve, compared to the trapezoidal forms described above for the cage 20, the retention of the balls or rolling bodies 13, precisely by increasing the points P of contact between the cage 50 and each respective ball or rolling body 13.

Both in the cage 20 and cage 50 discussed above, the meandering wire 21 may be made of metallic material with a circular, or square or also rectangular cross-section and, vice versa, the cross-sectional form being able to be used, depending on the working conditions, to determine the rigidity of the structure of the cage 20 or 50, thus avoiding any deformations under load.

Moreover, both in the cage 20 and cage 50 described above, the meandering wire 21 may have respective free ends 40, namely without any mechanical fastening system or any physical continuity between the said two free ends 40 so as to allow the geometrical form of the cages 20, 50 to be adapted to the balls or rolling bodies 13 in any rotation condition of the bearing 10. Moreover, the free ends 40 give rise to further advantages in terms of logistics and production costs since the cages 20, 50 may be produced with a planar development so that it can then be directly or indirectly calendered on the line for production of the bearing 10.

Alternatively, the ends 40 of the meandering wire 21 of the cage 20 or 50 may be joined together, namely with a mechanical fastening system or also a physical continuity between the ends 40, allowing the cages 20, 50 to reach very high speeds, while maintaining a constant and relatively limited friction value since there are nominally, in the direction of rotation of the bearing 10, two points P of contact between cage 20, 50 and balls or rolling bodies 13 in the case of the cage 20 and three in the case of the cage 50.

Furthermore, cage 20, which extends solely in a cylindrical development plane K, the diameter D2 of which has dimensions smaller than the dimensions of the diameter D1 of the pitch circle of the balls 13, offers a number of advantages or improvements over conventional technology in terms of assembly and retention of the balls or rolling bodies 13 since the smaller size of the seat 21 compared to that of the associated ball or rolling body 13 allows correct assembly of the cage 20, 50 in the bearing 10, preventing or avoiding the cage 20, 50 from being positioned on a pitch circle which is greater than that of the bearing 10, namely passing over the balls or rolling bodies 13 in the radial direction and therefore not performing its intended function.

Finally, since the cage 20, 50 comprises a geometrical form, as discussed above, the production costs and time may be reduced compared to already known cages, which requires dedicated machines and equipment with longer set-up and production times, and also simplifying quality control.

According to an alternative example embodiment of the cage 20 or the cage 50, which is not shown, but may be easily deduced from the above description, the meandering wire 21 may also be shaped and extend around the axis of rotation X in a conical development plane. Development is particularly suitable for the assembly of the associated cage in tapered ball bearings, namely in those bearings where the respective raceways for the balls 13 on inner ring 11 and the outer ring 12 are axially displaced with respect to each other so as to withstand combined loads both of the radial type and of the axial type.

One skilled in the art will appreciate that without modifying the principle of the inventive concepts disclosed herein, the example embodiments and the constructional details may be greatly varied with respect to that described and illustrated purely by way of a non-limiting example embodiments, without departing from the scope of the inventive concepts as described in the accompanying claims.

1. A cage for a ball bearing, comprising:
a meandering wire extending around an axis of rotation (X) of the ball bearing, the meandering wire comprises a plurality of seats, each seat configured to receive a respective ball of a plurality of balls; and
a separating element between each pair of adjacent seats of the plurality of seats, wherein for each seat, the three points (P) of contact are between the respective ball and the meandering wire so as to retain the respective ball inside the associated seat, the separating element being formed by the meandering wire and the three points (P) lying on the meandering wire.

2. The cage of claim 1, wherein for the each seat, two of the three points (P) of contact between balls and the meandering wire are positioned on the separating elements.

3. The cage of claim 2, wherein the each seat includes an axial opening laterally delimited by two separating elements, the each seat is axially delimited, on the opposite side of the axial opening, by an annular portion of the meandering wire; one point (P) of the three points (P) of contact between balls and the meandering wire being positioned on the annular portion of the meandering wire.

4. The cage of claim 1, wherein the meandering wire extends in a cylindrical development plane (K) coaxial with the axis of rotation (X), and with a first diameter (D2) having given dimensions, and a second diameter (D1) of the centres of the plurality of balls includes dimensions greater than the dimensions of the first diameter (D2).

5. The cage of claim 4, wherein each one of the separating element includes a substantially trapezoidal form in the cylindrical development plane (K).

6. The cage of claim 4, wherein each seat includes a substantially hexagonal form in the cylindrical development plane (K).

7. A cage for a ball bearing, comprising:
a meandering wire extending around an axis of rotation (X) of the ball bearing, the meandering wire comprises a plurality of seats, each seat configured to receive a respective ball of a plurality of balls; and
a separating element between each pair of adjacent seats of the plurality of seats, wherein for each seat, three points (P) of contact between the respective ball and the meandering wire so as to retain the respective ball inside the associated seat, the separating element being formed by the meandering wire and the three points (P) lying on the meandering wire,
wherein the meandering wire extends in a cylindrical development plane (K) coaxial with the axis of rotation (X), and with a first diameter (D2) having given dimensions, and a second diameter (D1) of the centres of the plurality of balls includes dimensions greater than the dimensions of the first diameter (D2).

8. The cage of claim 7, wherein the meandering wire includes opposing free ends, the opposing free ends are joined such that physical continuity of the meandering wire around the ball bearing is maintained.

9. The cage of claim 7, wherein the meandering wire includes opposing free ends, the opposing free ends not being joined to each other such that geometric form of the cage is configured to be adapted to the plurality of balls in any rotation condition of the ball bearing.

10. The cage of claim 7, wherein the meandering wire composed of metallic material with a circular, square or rectangular cross-section.

11. A cage for a ball bearing, comprising:
a meandering wire extending around an axis of rotation (X) of the ball bearing, the meandering wire comprises a plurality of seats, each seat configured to receive a respective ball of a plurality of balls; and
a separating element between each pair of adjacent seats of the plurality of seats, wherein for each seat, three points (P) of contact between the respective ball and the meandering wire so as to retain the respective ball inside the associated seat, the separating element being formed by the meandering wire and the three points (P) lying on the meandering wire,
wherein the meandering wire extends in a cylindrical development plane (K) coaxial with the axis of rotation (X), and with a first diameter (D2) having given dimensions, and a second diameter (D1) of the centres of the plurality of balls includes dimensions greater than the dimensions of the first diameter (D2), further wherein the meandering wire includes opposing free ends, the opposing free ends are joined such that physical continuity of the meandering wire around the ball bearing is maintained, further wherein the meandering wire includes opposing free ends, the opposing free ends not being joined to each other such that geometric form of the cage is configured to be adapted to the plurality of balls in any rotation condition of the ball bearing, further wherein the meandering wire composed of metallic material with a circular, square or rectangular cross-section.
